(19) United States
(12) Patent Application Publication
(10) Pub. No.: US 2013/0290323 A1
(43) Pub. Date: Oct. 31, 2013

(54) SYSTEMS AND METHODS FOR AUTOMATICALLY ASSOCIATING TAGS WITH FILES IN A COMPUTER SYSTEM

(71) Applicant: Joseph SAIB, Santa Clara, CA (US)

(72) Inventor: Joseph SAIB, Santa Clara, CA (US)

(73) Assignee: APPSENSE LIMITED, Warrington (GB)

(21) Appl. No.: 13/457,150

(22) Filed: Apr. 26, 2012

(51) Int. Cl. G06F 17/30

(52) U.S. Cl. 707/728; 707/722; 707/E17.014

(57) ABSTRACT

Systems and methods are provided for automatically associating tags with files in a computer system. In one method, the method comprises receiving a search request from a user containing a search keyword; retrieving results including one or more files responsive to the search request; receiving file information and the user's previous access information about the one or more files; selecting at least one eligible file from the one or more files based on the access information and the file information; identifying at least one tag based on at least one of the search keyword, the access information, and the file information; associating the tag with the eligible file; and storing the association of the tag with the eligible file.

### CROSS-REFERENCE TO RELATED APPLICATIONS

This application is related to the following applications, filed herewith and hereby incorporated by reference: “Systems and Methods for Providing Data-Driven Document Suggestions” (U.S. application Ser. No. ______) and “Systems and Methods for Mining Organizational Data To Form Social Networks” (U.S. application Ser. No. ______).

### BACKGROUND

1. Technical Field

Disclosed systems and methods relate to automatically associating tags with files in a computer system.

2. Description of the Related Art

Files in a computer system are often retrieved using search as a method for identifying the file, particularly in large collections of files where specifically identifying the file by file storage location becomes difficult. Search has limitations as well, stemming from its use of text strings to identify files, as many files contain identical or similar strings of text. This causes a large number of results to be returned for certain searches performed by a standard text search engine.

Some search systems attempt to mitigate the problem of ineffective textual searches by adding additional information to the files in the form of “tags.” Tags are short strings of text that are assigned to individual files or chunks of content such as metadata. More than one tag may be assigned to a file. The assigned tags are chosen informally and personally by the user of the system, and do not necessarily relate to the file's location in a hierarchical storage system. Tagging was popularized by its use on the Web by websites such as Flickr and weblogs using the WordPress content management system.

However, tags still require a user to manually designate and apply tags. As with other types of metadata, the disadvantage of using tags is that the tags must be applied. Further, tags are often idiosyncratic and specific to a user. It is difficult to automatically assign tags based on the contents of a document because such automatically-generated tags may not correspond to a user's specific preferences. Additionally, in a corporate environment, it may be impractical to apply tags to a large number of potential documents.

Therefore, there is a need in the art to provide alternative tagging systems for use on intranets and other networks. In particular, there is a need in the art to provide systems and methods that allow different users in an organization to perform tagging of documents on an intranet document storage system.

Accordingly, it is desirable to provide methods and systems that overcome these and other deficiencies of the related art.

### SUMMARY

In accordance with the disclosed subject matter, systems and methods are provided for automatically associating tags with files in a computer system.

The disclosed subject matter includes a method for automatically associating tags with files in a computer system, the method comprising receiving a search request from a user containing a search keyword; retrieving results responsive to the search request for presentation to the user, including one or more files; receiving file information and access information about the one or more files during a tagging process, selecting, during the tagging process, at least one eligible file and at least one tag based on the search keyword; and tagging the at least one eligible file with the at least one tag by associating each tag with each eligible file, wherein the selection of the least one eligible file is based on the search keyword, the results responsive to the search request, thereby not requiring the user to manually associate files and tags.

In accordance with the disclosed method, the access information indicates whether the user has previously opened, copied, modified, or shared the one or more files. The tag comprises at least one of the search keyword and a related term derived from the search keyword. The file information comprises one of a filename and a storage location. The file information comprises a file location that is similar to that of the one or more files. Retrieving the results includes the one or more files responsive to the search request from a file system controlled by a second user for presentation to the user. Identifying the at least one tag is performed by evaluating numeric scores representing relevance.

The disclosed subject matter includes a system for providing document tagging in a communications network is disclosed, the system comprising: one or more interfaces configured to provide communication with a server via communication network; and a processor, in communication with the one or more interfaces, and configured to run a module stored in memory that is configured to: receive a search request from a user containing a search keyword; retrieve results including one or more files responsive to the search request for presentation to the user; receive file information and access information about the one or more files, wherein the access information indicates whether the one or more files has been previously accessed by the user; select at least one eligible file from the one or more files based on at least one of the access information and the file information; identify at least one tag based on at least one of the search keyword, the access information, and the file information; tag the eligible file with the tag by associating the tag with the eligible file; and store the association of the tag with the eligible file.

In accordance with the disclosed system, the access information indicates whether the user has previously opened, copied, modified, or shared the one or more files. The tag comprises at least one of the search keyword and a related term derived from the search keyword. The file information comprises one of a filename and a storage location. The file information comprises a file location that is similar to that of the one or more files. The processor is configured to retrieve the results including the one or more files responsive to the search request from a file system controlled by a second user for presentation to the user. The processor is configured to identify the at least one tag by evaluating numeric scores representing relevance.

The disclosed subject matter includes a non-transitory computer-readable medium having executable instructions operable to cause a device to: receive a search request from a user containing a search keyword; retrieve results including one or more files responsive to the search request for presentation to the user; receive file information and access information about the one or more files, wherein the access information indicates whether the one or more files has been previously accessed by the user; select at least one eligible file from the one or more files based on at least one of the access information and the file information; identify at least one tag based on at least one of the search keyword, the access information, and the file information; tag the eligible file with the tag by associating the tag with the eligible file; and store the association of the tag with the eligible file.

In accordance with the disclosed medium, the access information indicates whether the user has previously opened, copied, modified, or shared the one or more files. The tag comprises at least one of the search keyword and a related term derived from the search keyword. The file information comprises one of a filename and a storage location. The file information comprises a file location that is similar to that of the one or more files. The device is operable to retrieve the results including the one or more files responsive to the search request from a file system controlled by a second user for presentation to the user. The device is also operable to identify the at least one tag by evaluating numeric scores representing relevance.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a network connectivity diagram of a networked system in accordance with some embodiments of the invention.

FIG. 2 is a flow diagram of automatically tagging documents in accordance with certain embodiments of the invention.

FIG. 3 illustrates a block diagram of a client device in accordance with certain embodiments of the invention.

FIG. 4 illustrates a block diagram of a server device in accordance with certain embodiments of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are only for examples, and that it is contemplated that there are other systems and methods that are within the scope of the disclosed subject matter.

Users of present-day computer systems often use arbitrary textual keywords called tags as metadata for documents or arbitrary content objects. These tags help describe the document and allow them to be found later by browsing or searching. Tags do not need to be related to the content of the document; instead, they are chosen informally by the user of the system to facilitate understanding and retrieval. For this reason, often a document will have multiple tags, and several of these tags may be different synonyms for the same general concept. This reduces the need for a user to subsequently remember the exact phrasing used in the document for purposes of later retrieval.

Tags became popular as a result of their use on various websites. They possess many advantages. One advantage of tags is that they can be simply visualized to facilitate browsing and retrieval. For any arbitrary number of documents, all tags used by those documents can be listed to provide a simple visualization. Often, multiple documents share the same tag, and an additional layer of information can thus be made visible by increasing the size of the text for tags that are presented more than once in the collection of documents. The resultant visualization is called a tag cloud, and its visual appeal provides a visualization that is easy to create and that allows a user to browse a collection of documents.

Another advantage of tagging in a document system is that unlike a file system that organizes files hierarchically, there is no explicit information about the meaning of each tag. Another advantage is that multiple tags may be applied to the same document. In storage systems where documents are organized in hierarchical file systems, it may be difficult or impossible to create an organization that is useful for all users. Tagging allows multiple users' organizational systems to coexist, facilitating document retrieval for all users.

Tagging thus depends heavily on users to identify appropriate and relevant tags. This can be considered a disadvantage of tagging. Often, applying tags to files is a repetitive and menial process. For example, if a user wishes to apply a tag to more the one file, the process may require repeating the tagging process for each file. If the files or the tags differ in one or more ways, the user must spend considerable attention applying the correct tags to each document. If more than one copy of the document exists on the system, the user may be required to tag all copies of the document. Further, it is likely that not all documents in the system are tagged. This may result in the user constantly encountering documents that need to be tagged, and tagging these documents may cause repeated interruptions to the user's workflow.

Additionally, although many users may spend the time needed to designate and apply such tags, not all users may do so. It is therefore one objective of this invention to allow users to apply tags with less effort, thereby increasing the number of users that apply tags, and improving the ability of all users to retrieve files as a result.

The present disclosure describes a method for automatically inferring tags for documents in a storage system. In some embodiments, the system may use information from other files, or other information, to infer tags and to retrieve documents based on the tags, without the user explicitly assigning the tags to each retrieved document. In some embodiments, the system may interpret a search based on search terms to automatically assign tags to documents based on the search terms. In some embodiments, the system may use tags assigned by other users on the system to infer tags for the current user, in some embodiments.

Tags constitute metadata associated with files. In some embodiments, other metadata associated with the file may be used to infer tags. For example, tags may automatically be assigned to a document based on the modification date, creation date, or other date associated with a document. Tags may automatically be assigned to a document based on the contents of the document, such as in a system that performs statistical analysis of text in a document. Tags may automatically be assigned to a document based on the file type of a document, such as tags for a photo, video, or other document. Tags may automatically be assigned to a document based on where the document is stored in a hierarchical document storage system. In each of these examples, the tags may be assigned by the system during periods of user inactivity, or the tags may be dynamically inferred at the time a user performs a search, without explicit assignment of the tags to the document and storage of the tags in a metadata store associated with the document. A subsequent search will return both documents with inferred tags and explicit tags.

For example, Joe may have pictures of his dog, Bubbles, stored in a directory titled “Pictures of my dog.” The documents in this directory may automatically be tagged “dog,” “Bubbles,” “pictures,” “photos,” and “my dog,” based on the information that can be gleaned from the directory structure. If the photos were taken recently, they could be tagged with the date, or with a human-readable tag related to the date, such as “last week.”

These tags could also be inferred at the time that Joe searches for these pictures. The system may retrieve results for a search, and then attempt to identify inferred tags based on the search terms, characteristics of the files retrieved by the search, or other factors. The system may performed an additional search based on the inferred tags, thereby retrieving additional documents that match the user's implied criteria. The inferred tags may be saved for future use by the system in a metadata store, associated with the documents retrieved by the search. In some embodiments, the user may be given the opportunity to confirm/accept or reject the association of the inferred tags to the retrieved documents. A subsequent search for the same search terms will return documents with the inferred tags, in addition to documents retrieved by the search based on their contents. In some embodiments, this subsequent search may be performed at the same time as the initial search, thereby augmenting all searches with the results of searching on inferred tags.

In some embodiments, tags explicitly assigned by the user may be handled differently than tags implicitly inferred by the system. For example, these tags may be given different weights. In some embodiments, a weight may be assigned to each inferred tag based on a level of confidence of the system in the specific inferred tag. This may be useful when some tags are based on predictive analysis of the contents of the documents, as such analysis may not always be correct. The level of confidence of the system in a specific inferred tag may consist of numeric weights, coefficients or scores, and may be based on one or more factors, including the specific data or metadata used to identify the tag, the user or users whose action was used to identify the tag, etc.

In some embodiments, the system may take into account documents tagged by other users. The documents may exist on a user's local machine or on a network server, or on a cloud store, or external to the network server, or on more than one of the above, or elsewhere. A search on these documents may incorporate the searching user's own tags, and may also incorporate tags assigned by other users. The search may also incorporate inferred tags, both from the searching user or from other users. The following method may be used to provide this functionality.

In some embodiments, a tag server is located on a network, and is accessible to two or more users on a system. The tag server includes a correlation module that serves to correlate tags assigned to documents by one user with tags assigned to the same documents by another user. The correlation module may also provide suggestions for inferred tags to one user based on tags assigned by, or inferred from tags assigned by, the other user. The tag server may also communicate tags assigned by one user to the other user. Storage of tags and search capability may be offered at the tag server, as well as on the computers of the two respective users.

Leveraging tags assigned by a large number of users within an organization has the ability to dramatically reduce manual assignment of tags by each individual user. This method may thus be adapted for use in a system where users are connected to each other in a social network. This social network may automatically be derived from a directory server, as described in U.S. patent application Ser. No. ______, “Systems and Methods for Mining Organizational Data to Form Social Networks,” filed Apr. 26, 2012, which is hereby incorporated by reference.

In some embodiments, tags may be automatically assigned or inferred based on information from the public Internet or on the organizational intranet. The Internet contains a number of resources, such as: websites that provide news stories related to search terms, such as Google News (http://news.google.com/); websites that provide web searches for search terms, such as Google (http://www.google.com/); websites that provide dictionary definitions and thesaurus entries, such as Dictionary.com (http://www.dictionary.com/); and websites that provide lexical databases for common words, such as WordNet (http://wordnet.princeton.edu/); or any other suitable website.

These public resources may be accessed to enhance the system's understanding of search terms by obtaining lists of related words and phrases to be used as tags, either inferred or explicitly applied. For example, a search for a document with the term “transport” may be augmented by searching on WordNet for the search term “transport,” which results in several additional terms being returned, including “conveyance,” “carry,” “shipping,” “transmit,” “transfer,” “ship,” and others. These terms could be incorporated as inferred tags at a tag server.

Retrieved results are parsed into tags, which may be used as inferred tags or explicitly assigned to documents, and the tags may be associated with the files retrieved by the original search terms in a centralized database at a network server.

Other resources may be available on the local intranet, such as equivalents of the resources described above, as well as other search and textual analysis tools that have access to databases that are privately maintained by a corporation or organization. Such databases may contain username and organizational information, like a directory server or lightweight directory access protocol (LDAP) server; may index private data and provide search services, such as a search appliance provided by Google or intranet search software provided by Autonomy, Verity, Endeca, Microsoft SharePoint, may provide access to customer relationship management (CRM) databases such as Siebel and PeopleSoft databases; enterprise relationship planning (ERP) databases such as SAP databases; archives of email and instant messaging traffic; and other systems. By performing a search for a set of search terms requested by a user in one or more of these intranet databases and reformatting or parsing the results, a set of term suggestions may be obtained that relate to the user's needs in the context of the organization.

User interaction may be incorporated to improve the accuracy of the term suggestion system, in some embodiments. For example, in the example above for the term “transport,” the user may be presented with a list of documents that match the initial search term, with the additional terms suggested by WordNet listed alongside each document. The user may click the terms that apply to each document to indicate which terms should be used as tags for that document. As another example, when showing a user results for the term search “greyhound,” the user may be presented by a grid of images that are returned by the search, but are not yet tagged with the term “greyhound.” Once the user selects or clicks one or more of the displayed images in the grid, the selected documents may be explicitly tagged with the term.

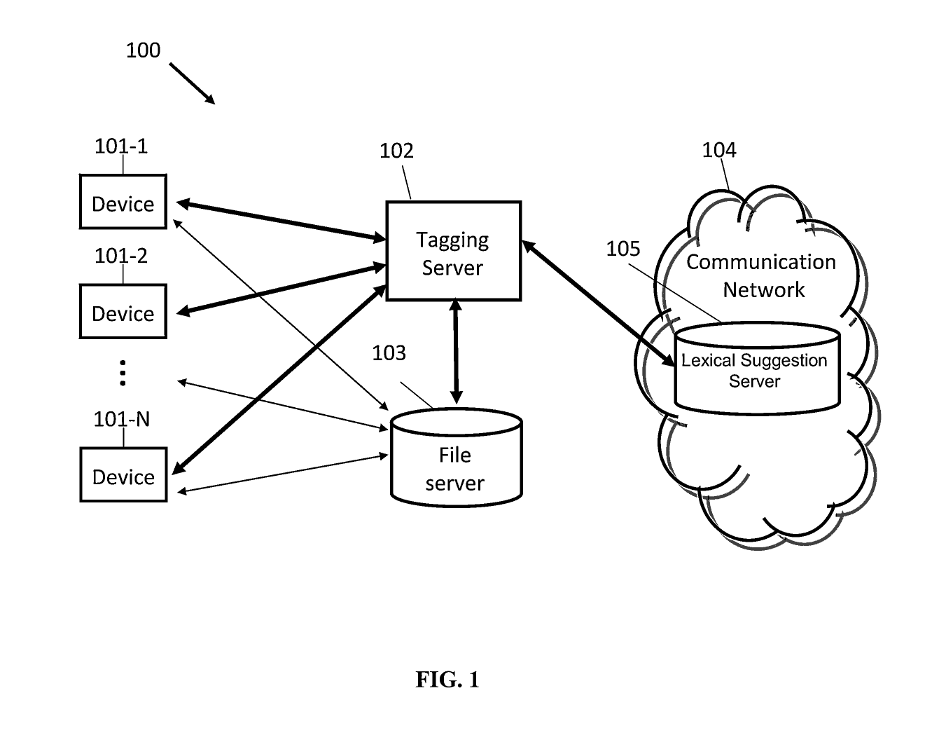

FIG. 1 is a network connectivity diagram of a networked system in accordance with some embodiments of the invention. Network system 100 is a client/server system, in which at least one client 101 (e.g., devices 101-1, 101-1, . . . 101-n), tagging server 102, and file server 103 communicate via a communication network 104. Tagging server 102 communicates with lexical suggestion server 105 via communication network 104. Device 101 is a mobile device or user-operated device associated with a user. Device 101 can be any suitable device, including desktop computers, mobile computers, tablet computers, and cellular phones, including smartphones (e.g., Apple iPhones, RIM BlackBerry devices, or Android-based smartphones). Users use device 101 to perform searches for documents and files on file server 103. When searches are performed on file server 103, device 101 also communicates with tagging server 102, which analyzes the search terms for the search and explicitly or implicitly assigns tags according to the disclosed embodiments of the invention.

File server 103 retrieves the requested documents and files, and sends them to device 101. File server 103 may be a standard Microsoft Windows file server, web server, WebDAV server, or other file server, in which case tagging server 102 may provide proxy capability to intercept requests for files before they are sent to the file server. File server 103 directly sends the files to the devices 101, in some embodiments. Tagging server 102 may provide search capability, and this search capability may be provided via a webpage served by tagging server 102, or via an enterprise search application such as Autonomy, or a document management system such as iManage WorkSite, or another system, according to some embodiments.

Tagging server 102 communicates with lexical suggestion server 105, which may be a website such as WordNet, or a local lexical analysis tool that analyzes textual data based on the corpus of documents available within the organization, or another system that can receive terms as input. The lexical suggestion server 105 is within communication network 104, which may be the public Internet, or may be a private intranet controlled by an organization or company, or may be another network.

Tags are identified based on relevance, which is calculated using numerical scores that represent the relative likelihood that a search relates to a file based on one of several factors. When potential tags are identified, the tags may be added to a list of potential tags, or they may be applied explicitly or implicitly to the file immediately. Additionally, the tagging system correlates new potential tags with tags that already exist on the system. When possible, tags can be reused.

In some embodiments of the invention, tagging server 102 may incorporate a social networking server, and tags may be shared among users in a social network, tags may be applied based on actions taken by other users in the social network and their relationship status with the searching user or viewing user or file owner, and tags may be implicitly applied or suggested based on tags that are explicitly or implicitly applied by other users. Further information about the social network aspects of the invention may be understood from U.S. patent application Ser. No. ______, “Systems and Methods for Mining Organizational Data to Form Social Networks,” filed Apr. 26, 2012, which is hereby incorporated by reference.

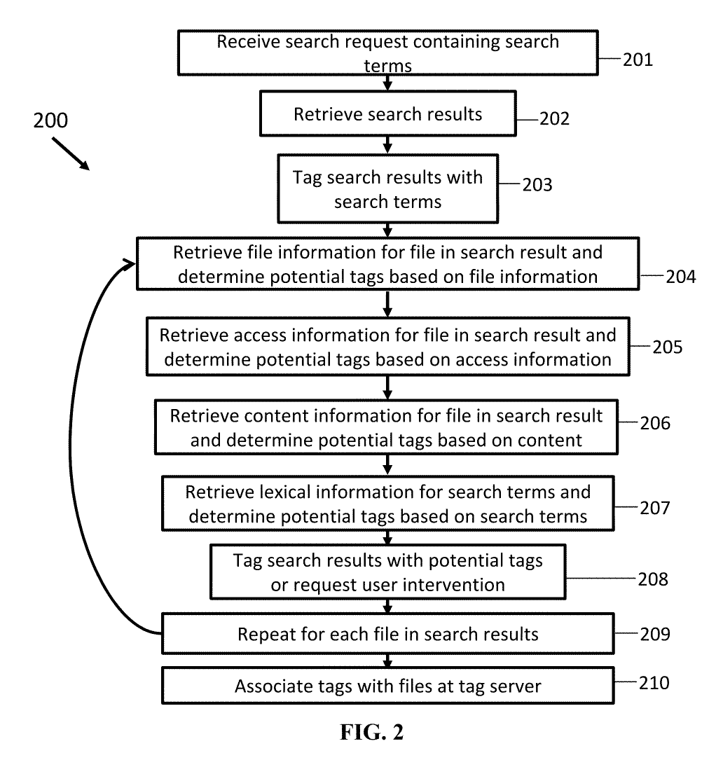

FIG. 2 is a flow diagram of identifying documents for suggestion in accordance with certain embodiments of the invention. Flow diagram 200 shows the following steps. At step 201, a tagging server receives a search request containing search terms. At step 202, search results are retrieved. The search results include files and/or documents. These files or documents are then tagged with the search terms at step 203. In some embodiments of the invention, the searching user is requested to confirm tagging of the search results. The tagging can be on a per-document basis, on a subset of the search results, or on the entire search results. In other embodiments of the invention, search results are automatically tagged without user intervention, thus allowing the tagging system to rapidly increase the number of tagged documents in the system.

At step 204, additional potential tags are identified from file metadata. This metadata may include: filename, file path, file creation date, file modification date, file owner, file creator, user who last accessed the file, title, date sent, date received, subject, file size, file type, file comments, or other metadata.

At step 205, access information for the file in the search results is retrieved and used to determine and identify potential tags. This information may include file access time, file modification time, user who last accessed the file, file access history, file search history (i.e., whether the file was searched for or appeared as a result in a search), or other information. Although information originating from or pertaining to other users of the system maybe used at every step of chart 200, access information pertaining to other users is particularly pertinent to identifying potential tags. At this step, access information about other files may be incorporated. For example, if another file that is accessed by the same user or a different user in the same directory as the current file is noted to have been accessed, the current file may have an increased likelihood of being tagged with the directory or with one or more tags related to the other file, or with other tags.

At step 206, the file is reviewed for tags based on content. This may include a lexical analysis step of text within the file, image analysis if the file is an image, optical character recognition (OCR) of an image file, transcription of an audio recording, or analysis of other types of files.

At step 206, textual information derived from the contents of the file may be passed to a lexical analysis server, such as lexical suggestion server 105 (shown in FIG. 1). The lexical analysis server may provide additional potential tags. Potential tags are correlated with other tags on the system and identified for implicit or explicit application to the file.

At step 207, lexical analysis is performed on the search terms. This analysis is similar to the analysis performed at step 206, and may include the use of lexical suggestion server 105, as described above.

At step 208, if user intervention is required, the tagging server solicits the information. This may be performed at a webpage, using an interactive texts terminal, using a graphical user interface (GUI), using a touch interface, or using audio or other sensory feedback, as appropriate. User interaction may be accomplished at the client device. The user may indicate whether or not he wishes tags to be explicitly or implicitly applied to the file. Alternatively, this step may be performed after potential tags are identified for several or all files.

At step 209, this process is applied to the next file in the search results.

If the user has indicated that one or more tags should be applied, or if no user intervention is required, tags are applied at the tagging server, at step 210. This step may entail a local tagging server on a client device or a remote tagging server on a remote device or server device. When a local tagging server is used, it is configured to communicate with a remote tagging server in some embodiments, to synthesize, aggregate, and standardized tags across multiple users and client devices.

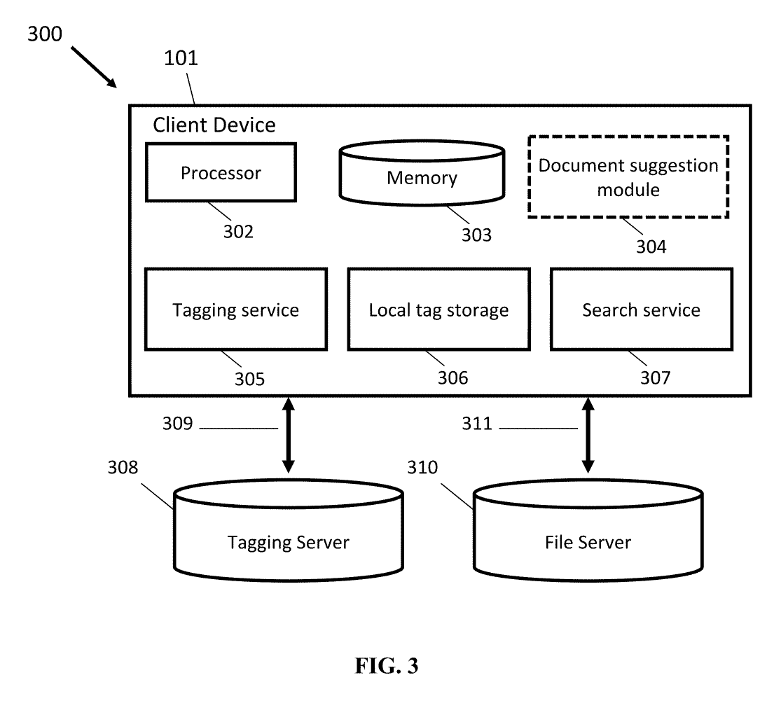

FIG. 3 is a block diagram of a client device in accordance with certain embodiments of the invention. Block diagram 300 shows client device 101, which includes processor 302, memory 303, document suggestion module 304, tagging service 305, local tag storage 306, and search service 307. Client device 101 is connected to tagging server 308 via interface 309 and fileserver 310 via interface 311. Interface 309 and interface 311 may be the same physical interface.

In some embodiments of the invention, client device 101 can include additional modules, fewer modules, or any other suitable combination of modules that perform any suitable operation or combination of operations. The memory 303 can be a non-transitory computer readable medium, flash memory, a magnetic disk drive, an optical drive, a programmable read-only memory (PROM), a read-only memory (ROM), or any other memory or combination of memories. The software runs on a processor 302 capable of executing computer instructions or computer code. The processor 302 might also be implemented in hardware using an application specific integrated circuit (ASIC), programmable logic array (PLA), field programmable gate array (FPGA), or any other integrated circuit.

At least interfaces 309 and 311 provides an input and/or output mechanism to communicate over a network. The interfaces 309 and 311 enable communication with servers, as well as other network nodes in the communication network. The interfaces 309 and 311 are implemented in hardware to send and receive signals in a variety of mediums, such as optical, copper, and wireless, and in a number of different protocols some of which may be non-transient. The interfaces 309 and 311 may be the same interface.

The client device 101 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, Apple iOS, RIM BlackBerry OS, Windows Mobile, Linux, HP WebOS, and Android. The screen may be a touch screen that is used to input data to the mobile device, in which case the screen can be used instead of the full keyboard. The user equipment can also keep global positioning coordinates, profile information, or other location information.

The client device 101 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 101 is configured with one or more processors 302 that process instructions and run software that may be stored in memory. The processor 302 also communicates with the memory and interfaces to communicate with other devices. The processor 302 can be any applicable processor such as a system-on-a-chip that combines a CPU, an application processor, and flash memory. The client device 101 can also provide a variety of user interfaces such as a keyboard, a touch screen, a trackball, a touch pad, and/or a mouse. The client device 101 may also include speakers and a display device in some embodiments.

When searching for one or more documents using search terms, or when assigning tags manually, tagging service 305 may perform several functions. These functions include: identifying tags, identifying whether user intervention is required, analyzing files and their contents to identify tags, correlating one set of tags with another set of tags to improve retrievability and consistency, and other functions. Tagging service 305 receives requests to assign tags as well. When tags are assigned, they are stored in local tag storage 306. Storing may occur in the form of an association between a file and a tag. They may also occur in the form of associations from between a file and a plurality of tags. Other associations may also be contemplated, in some embodiments. Local tag storage 306 may be synchronized with tagging server 308, periodically or on an as-needed basis or at other times. Search service 307 provides a user interface for searching for one or more files, and interfaces with tagging service 305. Search service 307 or tagging service 305 communicates with fileserver 310 to retrieve requested documents. Document suggestion module 304, if present, is used in conjunction with search service 307 to provide document suggestions, as described in U.S. patent application Ser. No. ______, “Systems and Methods for Providing Data-Driven Document Suggestions,” filed Apr. 26, 2012 and hereby incorporated by reference.

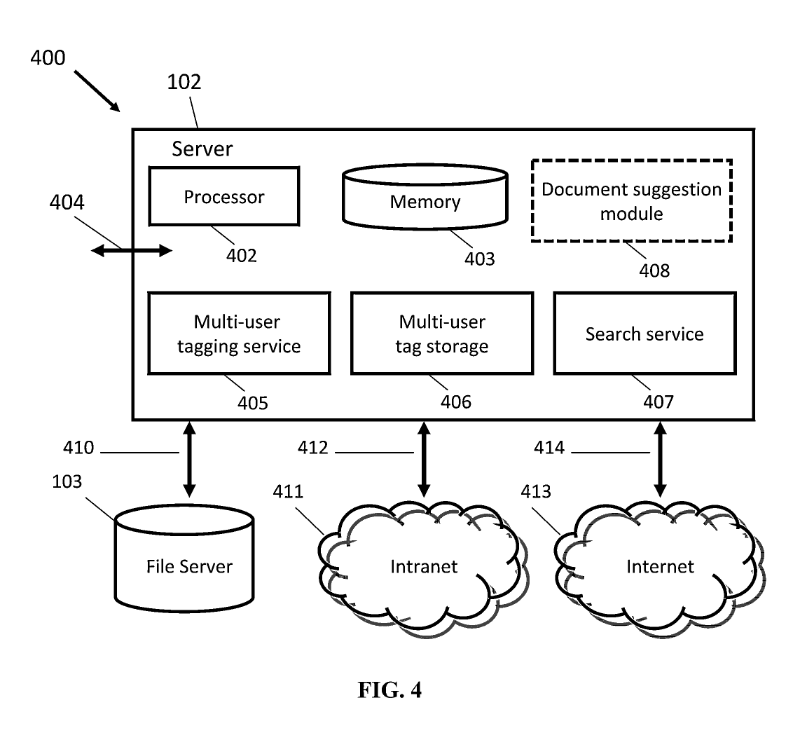

FIG. 4 is a block diagram of a server device, in accordance with some embodiments. Server device 102 includes processor 402, memory 403, multi-user tagging service 405, multi-user tag storage 406, search service 407, and document suggestion module 408. Server 102 communicates with client device 101 (not shown) via interface 404. Server 102 may communicate with file server 103 via interface 410. Server 102 may communicate with intranet 411 via interface 412. Server 102 may communicate with Internet 413 via interface 414.

As described for block diagram 400, a multi-user tagging service 405, a multi-user tag storage 406, and a search service 407 are provided. The operation of these modules is similar to the operation of the analogous modules in block diagram 300, but their function is performed across multiple users and is performed on any and all files available to server 102, which may be a superset of the files available to each local device. Multi-user tagging service 405 thus corresponds to tagging service 305 and provides tagging services for one or more users and uses tags that are used by all users; multi-user tag storage 406 corresponds to local tag storage 306 and stores tags used by all users; and search service 407 corresponds to search service 307 and provides search for documents stored on behalf of all users or that are made accessible on the network. Additionally, tags may be requested from multi-user tag service 405 by client devices 101, in order to provide consistent tags throughout an organization consisting of many client devices that provide and include tagging services. Additionally, more resources for identifying tags, particularly based on lexical analysis, may be available on intranet 411 and Internet 413, as described elsewhere herein. Document suggestion module 408 is also optionally provided for document suggestions.

Processor 402 performs processing for one or more modules as disclosed in this specification. Memory 404 provides temporary storage of data as required by the processor 402. The memory 404 can be a non-transitory computer readable medium, flash memory, a magnetic disk drive, an optical drive, a programmable read-only memory (PROM), a read-only memory (ROM), or any other memory or combination of memories. The software runs on a processor 402 capable of executing computer instructions or computer code. The processor 402 may also be implemented in hardware using an application specific integrated circuit (ASIC), programmable logic array (PLA), field programmable gate array (FPGA), or any other integrated circuit.

Although processor 402 performs each of the functions described in the flow diagram of FIG. 2, multiple sub-modules may exist within either the software or hardware of server 102 that provide supporting functionality.

The server 102 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 102. A task can be a software process that performs a specific function related to system control or session processing. Three types of tasks operate within the server 102 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 102 include a system initiation task subsystem, a high availability task subsystem, a shared configuration task subsystem, and a resource management subsystem.

The system initiation task subsystem is responsible for starting a set of initial tasks at system startup and providing individual tasks as needed. A high availability task subsystem works in conjunction with the recovery control task subsystem to maintain the operational state of the server 102 by monitoring the various software and hardware components of the server 102. A recovery control task subsystem is responsible for executing a recovery action for failures that occur in the server 102 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 102 with an ability to set, retrieve, and receive notification of server configuration parameter changes and is responsible for storing configuration data for the applications running within the server 102. A resource management subsystem is responsible for assigning resources (e.g., processor and memory capabilities) to tasks and for monitoring the task's use of the resources.

In some embodiments, the server 102 can reside in a data center and form a node in a cloud computing infrastructure. The server 102 can also provide services on demand. A module hosting a client is capable of migrating from one server to another server seamlessly, without causing program faults or system breakdown. The server 102 in the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. For example, while this disclosure discusses search in detail, other methods for retrieving documents may also provide embodiments that are in accordance with the invention, such as retrieval via browsing, retrieval using a hierarchical file structure, retrieval using a tag cloud, etc. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A method for automatically associating tags with files in a computer system, the method comprising:
receiving a search request from a user containing a search keyword;
retrieving results including one or more files responsive to the search request for presentation to the user;
receiving file information and access information about the one or more files, wherein the access information indicates whether the one or more files has been previously accessed by the user;
selecting at least one eligible file from the one or more files based on at least one of the access information and the file information;
identifying at least one tag based on at least one of the search keyword and the file information, and identifying at least one second tag based on the access information;
tagging the eligible file with the tag and the second tag by associating the tag and the second tag with the eligible file; and
storing the association of the tag and the second tag with the eligible file.

2. The method of claim 1, wherein the access information indicates whether the user has previously opened, copied, modified, or shared the one or more files.

3. The method of claim 1, wherein the tag comprises the search keyword and a related term derived from the search keyword, the method further comprising:
calculating the related term based on the search keyword;
storing the related term in a metadata store associated with the eligible file; and
retrieving the results including the one or more files comprises:
performing a first search based on the search request to identify a first set of files; and
performing a second search based on the related term to identify a second set of files, wherein the first set of files and the second set of files makes up the one or more files.

4. The method of claim 1, wherein the file information comprises one of a filename and a storage location.

5. The method of claim 1, wherein the one or more files has been previously accessed by the user, and wherein the file information comprises a file location that is similar to that of the one or more files.

6. The method of claim 1, further comprising retrieving the results including the one or more files responsive to the search request from a file system controlled by a second user for presentation to the user.

7. The method of claim 1, wherein identifying the at least one tag is performed by evaluating numeric scores representing relevance.

8. A system for providing document tagging in a communications network, the system comprising:
one or more interfaces configured to provide communication with a server via communication network; and
a processor, in communication with the one or more interfaces, and configured to run a module stored in memory that is configured to:
receive a search request from a user containing a search keyword;
retrieve results including one or more files responsive to the search request for presentation to the user;
receive file information and access information about the one or more files, wherein the access information indicates whether the one or more files has been previously accessed by the user;
select at least one eligible file from the one or more files based on at least one of the access information and the file information;
identify at least one tag based on at least one of the search keyword and the file information, and identify at least one second tag based on the access information;
tag the eligible file with the tag and the second tag by associating the tag and the second tag with the eligible file;
and
store the association of the tag and the second tag with the eligible file.

9. The system of claim 8, wherein the access information indicates whether the user has previously opened, copied, modified, or shared the one or more files.

10. The system of claim 8, wherein the tag comprises at least one of the search keyword and a related term derived from the search keyword.

11. The system of claim 8, wherein the file information comprises one of a filename and a storage location.

12. The system of claim 8, wherein the one or more files has been previously accessed by the user, and wherein the file information comprises a file location that is similar to that of the one or more files.

13. The system of claim 8, wherein the processor is configured to retrieve the results including the one or more files responsive to the search request from a file system controlled by a second user for presentation to the user.

14. The system of claim 8, wherein the processor is configured to identify the at least one tag is by evaluating numeric scores representing relevance.

15. A non-transitory computer-readable medium having executable instructions operable to cause a device to:
receive a search request from a user containing a search keyword;
retrieve results including one or more files responsive to the search request for presentation to the user;
receive file information and access information about the one or more files, wherein the access information indicates whether the one or more files has been previously accessed by the user;
select at least one eligible file from the one or more files based on at least one of the access information and the file information;
identify at least one tag based on at least one of the search keyword and the file information, and identify at least one second tag based on the access information; and
tag the eligible file with the tag and the second tag by associating the tag and the second tag with the eligible file;
store the association of the tag and the second tag with the eligible file.

16. The medium of claim 15, wherein the access information indicates whether the user has previously opened, copied, modified, or shared the one or more files.

17. The medium of claim 15, wherein the tag comprises at least one of the search keyword and a related term derived from the search keyword.

18. The medium of claim 15, wherein the file information comprises one of a filename and a storage location.

19. The medium of claim 15, wherein the one or more files has been previously accessed by the user, and wherein the file information comprises a file location that is similar to that of the one or more files.

20. The medium of claim 15, wherein the executable instructions are operable to cause the device to retrieve the results including the one or more files responsive to the search request from a file system controlled by a second user for presentation to the user.
